(19) United States
(12) Patent Application Publication
(10) Pub. No.: US 2006/0136512 A1
(43) Pub. Date: Jun. 22, 2006

(54) Method and system for replicating data between a community of distributed entities

(75) Inventor: Akram A. Bou-Ghannam, Lake Worth, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/017,344

(22) Filed: Dec. 20, 2004

(51) Int. Cl. G06F 17/30

(52) U.S. Cl. 707/203

(57) ABSTRACT

An information replication method for sharing information among a community of distributed, autonomous software entities. The method can include the step of within a particular one of the entities, detecting an information replication event. The particular entity can randomly select an entity from a community list specific to the particular entity. The community list can include entities within the community that the particular entity is aware of. Data can be replicated from a problem solving space of the particular entity to a problem solving space of the selected entity. After a specified interval, the randomly selecting step and the replicating step can be repeated.

### BACKGROUND

1. Field of the Invention

The present invention relates to the field of distributed networking and, more particularly, to communications between autonomous distributed software entities.

2. Description of the Related Art

Many industry leaders are attempting to implement methodologies that permit computer systems to function in a more distributed manner, where hardware resources are abstracted from applications that utilize these resources in the performance of application specific tasks. For example, a distributed application can utilize resources from multiple geographically disperse computing devices, depending on resource availability. One challenge with such distributed methodologies is system maintenance, which becomes increasing difficult and costly as the complexity of an underlying computing system increases. The concept of an autonomic computing system, or computing system that is able to largely manage itself and to gracefully handle computing system problems and workload, provides a solution to the problem of managing complex computing systems.

In an autonomic environment, intelligent autonomous entities collaborate on solving problems, where complex problems can require extensive collaboration between geographically disperse entities. Each of the entities in the autonomic environment can be modularly implemented and can function independent of one another. Moreover, each entity may not be aware of tasks being performed by other collaborating entities. Further, entities can be dynamically added and removed from the autonomic environment without substantially affecting existing processing tasks or collaboration efforts and without restarting the autonomic environment. Entities that collaborate on resolving problems in a particular domain can be considered a community of entities for that domain.

Traditional techniques for coordinating collaboration among the disparate and independent entities in a community is to use a centralized controller that implements a problem solving space for the entities. The centralized controller manages information flow between entities and coordinates the execution of entity performed tasks to ultimately achieve a desired result based upon returned responses from entities, the responses being the output generated by the entities resulting from the performed tasks. Reliance on centralized controllers can result in performance limitations, inefficiencies, and bottlenecks that becomes increasingly problematic as the number of entities increases.

What is needed is a method and a framework that allows entities in a community to cooperate using a decentralized problem solving space. Optimally, the problem solving space can be a virtual space shared among the entities in the community. Numerous problems exist, however, in creating a viable shared problem solving space. For example, in a complex autonomic system it can be difficult if not impossible for each entity to be fully aware of all of the other entities forming the community, as entities can be dynamically added and removed. Further, even if each entity in a community was aware of each of the other entities in the community, continuously sharing data between each entity's local space with the local spaces of all other entities in the community would be prohibitively time consuming and extraordinarily inefficient.

### SUMMARY OF THE INVENTION

The present invention offers a solution to the traditional problems associated with managing entities in a community using a centralized controller. Instead of attempting to centrally control a community, a loosely coupled community of entities can be formed, each utilizing a common domain-specific vocabulary. The common vocabulary can specify agreed upon meanings, domain events, domain states, domain conditions, and the like. Each entity can utilize this common vocabulary when implementing its own localized rules, procedures, and knowledge. Entities can communicate with one another by sharing sections of working memory, which can also be called “replicating a local problem solving space”.

Each entity can replicate a local problem solving space to one or more (preferably a small number for purposes of efficiently) entities within the community, which are known to the information conveying entity. The replication can be repeated at regular (or irregular) intervals, where the intervals can be based upon one or more replication conditions, which can be configurable values. The replication conditions can be configured on an entity by entity basis. Of course, for configuration purposes entities can also be grouped, where group configuration settings can be applied to each entity in the associated group. A random factor can be used when selecting the entities to which the local problem solving space is to be replicated, which can help distribute overall processing loads among the various entities.

One aspect of the present invention can include an information replication method. The method can include the step of providing a plurality of autonomous software entities distributed throughout a networked computing space. A first entity of the plurality can initiate a replication event. Responsive to the replication event, the first entity can select a second entity of the plurality from a list of entities, the list being specific to the first entity. Data can be replicated from a problem solving space local to the first entity to a problem solving space local to the second entity. In one embodiment, the entire problem solving space of the first entity can be replicated and the second entity can be the only entity that receives the replicated data.

Another aspect of the present invention can include a community of entities, which can include distributed, independent software entities. Each entity can have a working memory and a domain vocabulary common to all the software entities of the community. Each entity can perform programmatic actions in accordance to the domain vocabulary and entity specific rules and information.

Each entity can also include an entity maintained list of entities. Within the community, replication events can independently occur within each entity on an iterative basis that is independently configurable for each entity. Each replication event can cause the associated entity to select an entity from its included list and to copy information from its working memory to a working memory of a selected entity.

It should be noted that the invention can be implemented as a program for controlling a computer to implement the functions described herein, or a program for enabling a computer to perform the process corresponding to the steps disclosed herein. This program may be provided by storing the program in a magnetic disk, an optical disk, a semiconductor memory, any other recording medium, or distributed via a network.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a community of distributed entities in accordance with an embodiment of the inventive arrangements disclosed herein.

FIG. 2 is a schematic diagram illustrating a framework for an entity in accordance with an embodiment of the inventive arrangements disclosed herein,

FIG. 3 is a flow chart illustrating a method for replicating information between entities of a community in accordance with an embodiment of the illustrative arrangements disclosed herein.

### DETAILED DESCRIPTION OF THE INVENTION

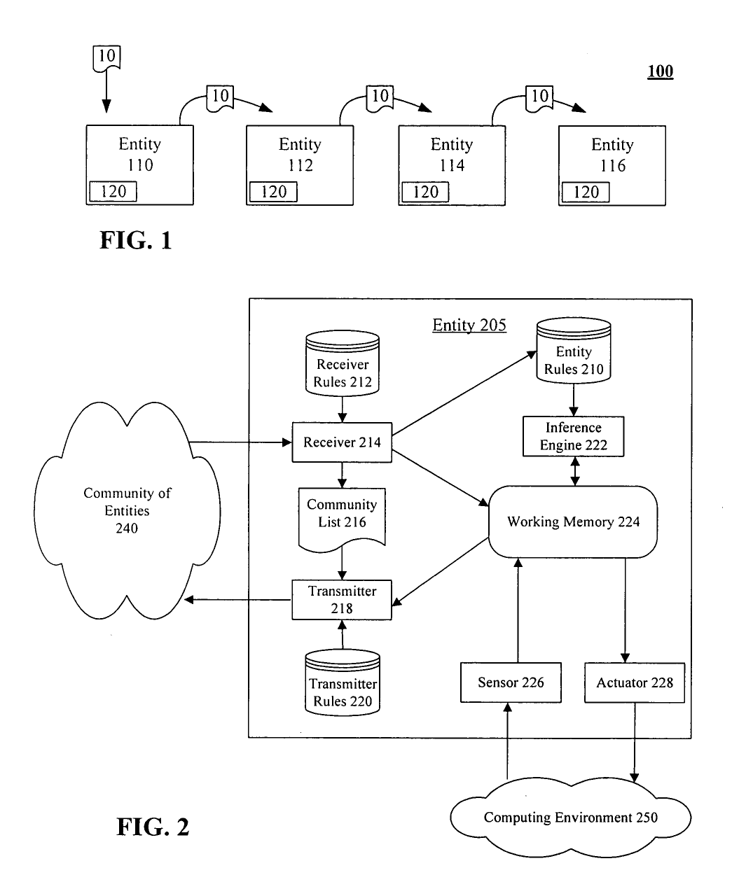

FIG. 1 is a schematic diagram of a community 100 of distributed entities 110-116 in accordance with an embodiment of the inventive arrangements disclosed herein. The community 100 can be a dynamic and inherently redundant environment, where entities 110-116 can be dynamically added and removed from the community 100, thereby adding and removing resources for handling domain related activities.

Each entity 110-116 can represent a software object or software agent. In particular embodiments, each entity 110-116 can be written in a modular and autonomous fashion so that entities 110-116 operate in an independent manner. Consequently, entity 110-116 activities are based upon localized rules, procedures, and knowledge possessed by and conferred to each entity. The entities 110-116 can collaborate to solve complex domain-specific problems in accordance with a domain vocabulary 120.

The domain vocabulary 120 can specify domain-specific meanings, domain events, domain states, domain conditions, domain constraints, domain syntax, and the like. The domain vocabulary 120, therefore, defines a common ontology shared by entities 110-116 that permits the entities to collaborate with one another.

In one embodiment, each entity 110-116 can convey information 10 from its local problem solving space or working memory to the local problem solving space of one or more other entities 110-116 in the community 100, each entity 110-116 reacting to and/or modifying the information 10 in accordance with its own internal rules as interpreted in light of the domain vocabulary 120.

It should be appreciated that each entity 110-116 can communicate with other software entities using any communication mechanism capable of conveying digitally encoded information. For example, entities 110-116 can convey information 10 across any network, circuit board, information bus, or combinations. Thus, entities 110-116 can communicate across wireless as well as line-based networks in accordance with any definable communication protocol, which includes, but is not limited to, a packet-based communication protocol as well as a circuit based communication protocol.

It should also be appreciated that each entity 110-116 can be implemented in any of a variety of fashions known in the art. For example, each entity 110-116 can be implemented as machine-readable code fixed within or written specifically for a particular hardware component or components. In another example, each entity 110-116 can be written as hardware agnostic machine-readable code segments. The machine-readable code of the entities 110-116 can be geographically centralized within a single computing device or can be distributed across a network space.

FIG. 2 is a schematic diagram illustrating a framework for an entity 205 in accordance with an embodiment of the inventive arrangements disclosed herein, where the entity 205 can be one implementation of entities 110-116 of FIG. 1. The entity 205 can interact with other entities within the community of entities 240, where the community of entities 240 represents a set of entities that operate in accordance with a common domain vocabulary, which is also utilized by entity 205.

To exchange information with the community 240, the entity 205 can utilize a receiver 214 and a transmitter 218. The receiver 214 can receive information from other entities in the community 240. The transmitter 218 can send information to other entities in the community 240. A receiver rules store 212 can specify filters, protocols, data conventions, and other entity 205 specific rules needed for processing input for the conventions of the entity 205. Similarly, a transmitter rule store 220 can specify filters, protocols, data conventions, and the like that the transmitter 218 uses in processing output to the community of entities 240.

Entity 205 can also interact with computing environment 250 using a sensor 226 and an actuator 228. The sensor 226 can gather input from the computing environment 250. The Actuator 228 can generate output sent to the computing environment 250.

Input received through receiver 214 and sensor 226 can be placed within working memory 224 or processed by inference engine 226 in accordance with rules established within entity rule store 210. The domain vocabulary used by entity 205 can be stored in entity rule store 210 along with entity-specific rules.

The inference engine 222 can use data within working memory 224 to perform one or more programmatic actions in accordance with the entity rules 210 in response to received input. In performing these programmatic actions, the inference engine 222 can alter information of the working memory 224 and can also generate output.

When the output is directed to the community of entities 240, the entity to which data is to be conveyed can be selected from a community list 216. The community list 216 can represent a set of entities that the entity 205 is aware of and can vary from entity to entity. In particular embodiments, a randomizing factor can be used when selecting the entity from the community list 216.

It should be noted that the data stores 210, 212, and 220 can store information in any recording medium, such as a magnetic disk, an optical disk, a semiconductor memory, or the like. Further, each of the data stores 210, 212, and 220 can utilize any information retention technique including a file-based storage technique or a database storage technique. Moreover, each of the data stores 210, 212, and 220 can be a storage area fixed to a geographical location or a storage area distributed across a network space.

It should also be noted that the arrangements shown in FIG. 2 are for illustrative purposes only and that the invention is not limited in this regard. The functionality attributable to the various components can be combined or separated in different manners than those illustrated herein. For instance, the sensor 226 and actuator 228 can be integrated as a single component in one embodiment of the invention disclosed herein.

In another example, the working memory 224 can be segmented into a plurality of different memory spaces, each storing information for a particular task. When the working memory 224 is segmented, the transmission of a problem solving space to an entity in the community 240 can constitute conveying selected ones of the different memory spaces.

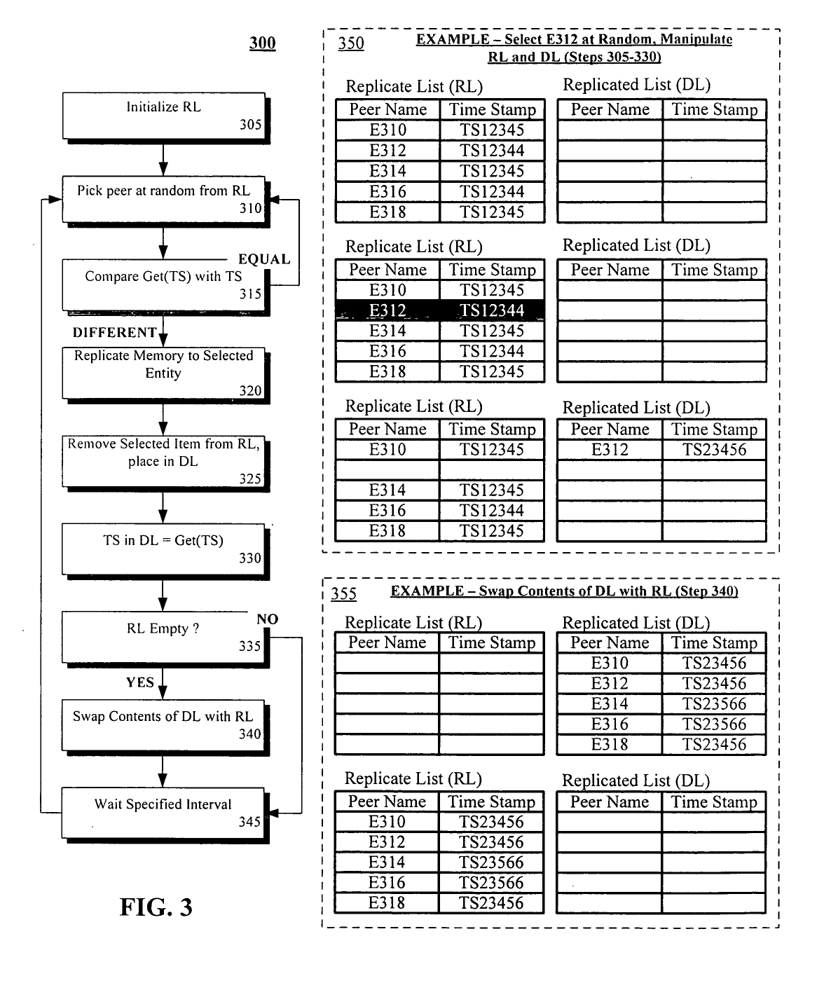

FIG. 3 is a flow chart illustrating a method 300 for replicating information between entities of a community in accordance with an embodiment of the illustrative arrangements disclosed herein. The method 300 can be performed in the context of a community 100 of entities 110-116 that communicate in accordance with a common domain vocabulary 120. Each of the entities 110-116 can include a community list 216 that specifies entities to which data can be replicated. The individual community lists 216 can differ from entity to entity and can be dynamically updated on an entity by entity basis.

The method 300 can begin in a state where data is to be conveyed from a data originating entity to a selective one of the entities in the community of entities. In step 305, a replicate list (RL) can be initialized. A different list called a replicated list (DL) can also be used during method 300. The replicate list and the replicated list are both lists specific to the data originating entity.

Example 350 shows an initial state for both the replicate list and the replicated list. In this example, the replicate list includes five peer entities (E310, E312, E314, E316, and E318). Each peer can have an associated time stamp (TS), such as TS12345 and TS12344. Each time stamp represents a state of the problem solving space when a replication occurred. As information changes in the problem solving space, new time stamps representing the new state of the problem solving space are generated. Because E310, 314, and E318 have the same time stamp (TS12345), the same data was replicated to these entities. Different data, represented by time stamp TS12344, was replicated to entity E312 and E316.

In step 310, a peer can be selected at random from the replicate list. In example 350, E312 is the randomly selected peer. In step 315, a current time stamp, which can be returned from a procedure called Get(TS), can be compared with the TS associated with the selected entity. When the time stamps are equal, the data within the randomly selected entity represents current data so the method can loop to step 310, where a different peer can be randomly selected.

When the time stamps from step 315 are different, the data within the selected entity differs from that contained within the originating entity and the method can proceed to step 320. In step 320, working memory of the originating entity (also called the problem solving space of the originating entity) can be replicated to the selected entity. In step 325, the selected entity entry can be removed from the replicate list and placed in the replicated list. In example, 350, the removal of E312 can be seen.

In step 330, the time stamp of the relocated entity can be set to a time stamp, which can be acquired with a Get(TS) operation. So if for purposes of example 350, the current time stamp equals TS23456, the entry within the replicated list for E312 can be associated with TS23456.

In step 335, if the replicate list is not empty, the method can proceed to step 345, where a specified time interval can pass until data is to again be sent to another entity. If the replicate list is empty in step 335, the method can proceed from step 335 to step 340 where the contents of the replicated list can be swapped with the contents of the replicate list.

Example 355, shows this step. Before the swap operation, the replicate list is initially empty and the replicated list contains entries for E310, E312, E314, E316, and E318. After the swap operation, the replicated list is empty, and the replicate list contains entries for E310, E312, E314, E316, and E318.

The method can proceed from step 340 to step 345, where again the method can pause for a specified interval. The method can loop from step 345 to step 310 after this period when data is to again be replicated to another peer in the community, where another peer can be picked at random from the replicate list.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

1. An information replication method for sharing information among a community of distributed, autonomous software entities comprising the steps of:
within a particular one of said entities, detecting an information replication event;
said particular entity, randomly selecting an entity from a community list specific to said particular entity, said community list including entities within the community that said particular entity is aware of;
replicating data from a problem solving space of said particular entity to a problem solving space of the selected entity; and
after a specified interval, repeating said randomly selecting step and said replicating step.

2. The method of claim 1, wherein each entity of the community repetitively performs said randomly selecting step and said replicating step in accordance with an entity-specific community list and an entity-specific replication interval

3. The method of claim 1, wherein said specified interval is a configurable value that establishes a data replication cycle for the particular entity, and wherein each entity in the community has an entity-specific interval that is individually configurable.

4. The method of claim 1, wherein said community list includes a subset of the entities of the community and does not include a complete listing of the entities of the community.

5. The method of claim 4, wherein each entity of the community includes a different entity-specific listing containing a subset of the entities of the community.

6. The method of claim 1, further comprising the steps of:
retrieving a time stamp associated with the selected entity;
comparing the retrieved time stamp with a current time stamp to determine whether the selected entity contains a current version of the problem solving space; and
performing the replicating step only when the retrieved time stamp is not current.

7. The method of claim 1, said method further comprising the steps of:
the particular entity detecting an entity which is not currently contained within the community list; and
automatically adding the detected entity to the community list.

8. The method of claim 1, said method further comprising the steps of:
the particular entity identifying that one of the entities listed in the community list has been removed from the community; and
automatically removing the identified entity from the community list.

9. The method of claim 1, further comprising the steps of:
within the selected entity, detecting an information replication event;
said selected entity, randomly choosing an entity from a community list specific to said selected entity, said community list including entities within the community that said selected entity is aware of;
replicating data from a problem solving space of said selected entity to a problem solving space of the chosen entity; and
after a specified interval, the selected entity repeating said randomly selecting step and said replicating step.

10. The method of claim 1, further comprising the steps of:
after said selecting step and before said repeating step, adjusting a value relating to the selected entity so that other entities in the community list are more likely to be randomly selected over the selected entity when the randomly selecting step is repeated.

11. The method of claim 10, wherein the community list is a replicate list, said method further providing a replicated list, wherein the adjusting step, removes the selected entity from the replicate list and places the selected entity into the replicated list.

12. The information replication method of claim 11, further comprising the steps of:
before the repeating step, determining that no entities are contained within the replicate list;
coping the entities within the replicated list into the replicate list; and
removing the copied entities from the replicated list.

13. A community of entities comprising:
a plurality of distributed, independent software entities, each entity having a working memory and a domain vocabulary common to all the software entities, wherein each entity performs programmatic actions in accordance to the domain vocabulary and entity specific rules and information;
and wherein each entity includes a list of entities within a community of entities that utilize the domain vocabulary, wherein replication events independently occur within each entity on an iterative basis that is independently configurable for each entity, each replication event causing the associated entity to select an entity from its included list and to copy information from that entities working memory to a working memory of a selected entity.

14. The community of claim 13, wherein the selection of entities responsive to each replication event occurs randomly.

15. The community of claim 13, wherein each the list of entities maintained by each entity is an entity-specific list that contains those entities within the community that are known to the entity associated with the list, wherein not all entities within the community are included in each entity-specific list.

16. The community of claim 13, wherein each entry in the lists of entities is associated with a time stamp signifying a memory state when the entity containing the list last shared information with the entity associated with the entry.

17. A machine-readable storage having stored thereon, a computer program having a plurality of code sections, said code sections executable by a machine for causing the machine to take programmatic actions directed towards sharing information among a community of distributed, autonomous software entities, the code sections causing the machine to perform the steps of:
within a particular one of said entities, detecting an information replication event;
said particular entity, randomly selecting an entity from a community list specific to said particular entity, said community list including entities within the community that said particular entity is aware of;
replicating data from a problem solving space of said particular entity to a problem solving space of the selected entity; and
after a specified interval, repeating said randomly selecting step and said replicating step.

18. The machine-readable storage of claim 17 wherein each entity of the community repetitively performs said randomly selecting step and said replicating step in accordance with an entity-specific community list and an entity-specific replication interval.

19. The machine-readable storage of claim 17, wherein said community list includes a subset of the entities of the community and does not include a complete listing of the entities of the community.

20. The machine-readable storage of claim 17, further causing the machine to perform the steps of:
retrieving a time stamp associated with the selected entity;
comparing the retrieved time stamp with a current time stamp to determine whether the selected entity contains a current version of the problem solving space; and
performing the replicating step only when the retrieved time stamp is not current.

21. The machine-readable storage of claim 17, further causing the machine to perform the step of:
after said selecting step and before said repeating step, adjusting a value relating to the selected entity so that other entities in the community list are more likely to be randomly selected over the selected entity when the randomly selecting step is repeated.
